(19) United States
(12) Patent Application Publication
(10) Pub. No.: US 2002/0035643 A1
(43) Pub. Date: Mar. 21, 2002

(54) Search support device and method, and recording medium storing program for computer to carry out operation with said search support device

(76) Inventor: Fujio Morita, Kawasaki (JP)

Correspondence Address: STAAS & HALSEY LLP, 700 11TH STREET, NW, SUITE 500, WASHINGTON, DC, 20001, US

(21) Appl. No.: 09/841,038

(22) Filed: Apr. 25, 2001

Related U.S. Application Data
(63) Continuation of application No. PCT/JP99/05376, filed on Sep. 30, 1999.

(30) Foreign Application Priority Data
Oct. 26, 1998 (JP) 10-304395

(51) Int. Cl. G06F 15/16; G06F 17/30

(52) U.S. Cl. 709/245; 707/3; 707/10; 709/217; 707/104.1

(57) ABSTRACT

The present invention relates to a search support device and method in which URL addresses are classified into categories and registered. By this device and method, the category of an address indicating the location of information that can be accessed on a network is determined from an address already registered, and the address is registered under the determined category.

### TECHNICAL FIELD

The present invention relates to a search support device and method, and, more particularly, to a search support device and method by which URL addresses are classified into different categories. The present invention also relates to a recording medium that stores a program for a computer to perform an operation with the search support device.

### BACKGROUND ART

Today, the Internet has widely spread as a computer network used across the world. There are no governments or organizations that manage the Internet, but a large number of groups operate and support the Internet in terms of technology and resource. The services and information that are available on the Internet are developing day by day with the evolution of technology, and it is never easy to quickly obtain desired information from the Internet.

In order to obtain desired information from the huge amount of information on the Internet, search engines have been developed. A search engine is a system specially developed for search. There are three types of search engines: a first one is a keyword-inputting type; a second one is a categorized type; and a third one is a keyword-inputting and categorized type.

A user of the Internet normally acquires information from hypertext documents written in the HTML (HyperText Markup Language) accumulated in the WWW (World Wide Web) server. Each of the hypertext documents is called a “homepage”. A user can access a homepage by software developed for accessing files in the HTML. This software is called “browser”.

When a user searches for information, the URL (Uniform Resource Locators) that indicates the location of the homepage containing the desired information on the Internet is searched for by the search engine, and the user accesses the homepage at the obtained address with the browser.

If the user comes to like the homepage accessed through the search, the user can register the URL address of the homepage, using one of the functions of the browser. The name of this function might vary depending on which browser is used, but will be hereinafter referred to as “bookmark” in this specification.

A URL address is normally made up of a plurality of character strings, and needs to be inputted every time an access is made to a homepage. However, while a homepage is being accessed, the bookmark is registered, so that the homepage can be promptly accessed by simply selecting the URL address from a list of registered bookmarks next time the user makes an access to the homepage.

Referring now to FIGS. 1 to 3B, the processes for searching for a homepage supposedly containing desired information with a search engine and registering the bookmark for the homepage will be described. FIG. 1 is a flowchart of a series of processes for homepage search and bookmark registration. FIGS. 2A to 3B show examples of browser screens displayed on a display unit.

When the search engine is activated, a keyword input stand-by screen is displayed as shown in FIG. 2A in step S10. If the user wish to search for a homepage on weather forecast, for instance, the user inputs the words “weather forecast” as a search keyword in step S11, and the search process is then carried out in step S12. As a result of the search process, a plurality of titles of homepages starting from “weather across the country” is displayed as shown in FIG. 2B.

The user then determines whether or not it is necessary to limit the desired information to a more specific keyword in step S13. If it is determined that the desired information should be more limited (“YES” in step S13), the user again inputs the more specific keyword in step S14, and the search process is carried out in step S12.

For instance, if the user wish to acquire some information on the weather in the Kanto region, instead of the weather across the country, the user inputs the words “Kanto region” as a keyword, as shown in FIG. 2C in step S14, and the search process is again carried out in step S12. As a result of the search process, a plurality of homepages starting from a homepage entitled “Weather Report in the Kanto Region” are displayed as shown in FIG. 2C.

The user again determines whether or not the keyword for the necessary information should be further limited in step S13. If there is no need to limit the keyword (“NO” in step S13), a homepage the user wish to access is selected from the list of homepages and then accessed as shown in FIG. 2D in step S17.

It is then determined whether or not a bookmark registration should be carried out for the accessed homepage in step S15. If it is determined that the bookmark registration should be carried out for the accessed homepage (“YES” in step S15), the bookmark registration is carried out as shown in FIG. 3A in step S16. For instance, the item “bookmark” shown in FIG. 2D is selected to register the URL of the currently accessed homepage along with its title.

With the bookmark registration, the homepage entitled “Weather Report in the Kanto Region” is promptly accessed and displayed, as shown in FIG. 3B, by simply selecting the title from the list of registered bookmarks shown in FIG. 3A. If it is determined that the bookmark registration is not necessary for the accessed homepage (“NO” in step S15), the bookmark registration is not carried out for the accessed homepage.

As described above, the bookmark registration is carried out for a homepage to be frequently accessed, so that an access can be easily made to the homepage.

However, the information including the URL address of each registered homepage (hereinafter referred to as “homepage information”) is registered as the list of registered bookmarks as shown in FIG. 3A. As the number of registered bookmarks increases, it becomes more difficult to select a desired homepage. Also, homepages having similar information might be mistaken for each other.

In such a case, the user may categorize the registered bookmark information. However, such a process complicates the overall operation.

Meanwhile, the categories used with the search engine are predetermined by the homepage of search engine. As a result, the search cannot be carried out using categories that are easy for the user to recognize.

Furthermore, the user needs to use predetermined characters for each keyword, otherwise the homepage containing desired information cannot be searched for.

If the user does not use the predetermined characters for a search keyword, the user repeatedly inputs a search keyword and repeats the search process, which results in a longer line using time and a higher line charge.

### DISCLOSURE THE INVENTION

The present invention aims to solve the above problems, and a first object of the present invention is to provide a search support device and method by which a user can register homepage information classified into various categories through a simple operation.

A second object of the present invention is to provide a search support device and method that can construct a category menu in which information is classified into categories easy for users to understand, generate a search character string used for a search process by a search engine based on the selection of the category menu, and restrict an increase in line charge by shortening the usage time of the telephone line.

A third object of the present invention is to provide a recording medium that stores a program for a computer to perform an operation with the above search support device.

To achieve the first object, the present invention provides a search support device which registers an address indicating the location of information that can be accessed on a network. This search support device includes: a search unit that determines the category of an address designated for registration based on a registered address; and a registration unit that registers an address under the determined category.

With this search support device, a user uses a search engine to search for a homepage containing desired information among homepages written in the HTML format accumulated on the WWW sever on the Internet. Here, the user inputs search information associated with the desired information into the search engine, thereby detecting the homepage containing the search information.

The user then actually accesses the detected homepage with the browser, and checks the contents. If there is a homepage the user comes to like, the information such as the address and title of the homepage can be registered in a bookmark registration process. In this case, the search support device of the present invention classifies the information such as the address and title of the homepage requested for the bookmark registration.

The search information inputted into the search engine is formed by a search character string that is considered to be related to the desired information. Accordingly, by analyzing and registering the information such as the address of the homepage based on the search information, all the information can be classified into categories that the user can easily recognize.

When located on the same level as an address designated for registration, the address should be registered under the category in which an address has already been registered. In view of this, the registration unit of the search support device of the present invention may register an address designated for registration under the category in which an address has already been registered.

With this search support device, an address designated for registration can be additionally registered in the category of a registered address.

Further, to achieve the first object, the present invention provides a search support method in which an address indicating the location of information accessible on a network. This method includes the steps of: determining a category of an address designated for registration based on an address that has already been registered; and registering an address in the determined category.

To achieve the second object, the present invention provides a search support device in which a search process for an address indicating the location of desired information on a network is requested based on search information associated with the desired information. This search support device includes: a category menu storage unit that stores a category menu in which predetermined categories are listed up; and a search information generation unit that generates search information associated with a category selected from the category menu.

With such a search support device, a category menu in which information is classified into categories is formed in a client computer, without the use of the categories prepared in a homepage containing a search engine. The category menu prepared in the client computer may be produced by a user, or produced based on data supplied from a server computer.

The category menu prepared in the client computer contains search information related to each category. Accordingly, a user selects a category containing desired information from the category menu prepared in the client computer, thereby automatically producing search information to be inputted into the search engine. In this manner, when a user searches for a homepage containing desired information, a suitable search character string is automatically inputted. Thus, the line using time can be shortened, and the telephone charge can be restricted.

The information such as the location and title of a homepage that has been registered through a bookmark registration process can be registered in association with the category menu prepared in the client computer. In view of this, the search support device of the present invention may further include an address registration unit that registers an address indicating the location of the desired information searched for based on the search information generated by the search information generation unit in the category menu, if the information at the address is accessible.

With this search support device, the information such as the location and title of a homepage searched for is classified in accordance with information that can be accessed at the address, and registered as a part of the category menu prepared in the client computer. As a result, even if the amount of homepage information to be registered becomes voluminous, the information of a desired homepage can be easily selected by carrying out a search process in accordance with the category menu.

Also, the information of a homepage registered as a part of the category menu prepared in the client computer is selected so as to make an access to the homepage. In view of this, the search support device of the present invention may include an address selection unit that accesses the location of desired information by selecting an address registered in the category menu.

In such a search support device, the information of a desired homepage can be easily selected in accordance with the category menu. From the information of the selected homepage, the search support device acquires the address of the homepage, and makes an easy access to the homepage with the browser.

If homepage information is registered as a part of the category menu, the category in which the homepage information is registered can be made visually recognizable. In view of this, the search support device of the present invention may further include an icon conversion unit that visually changes the category in which the address is registered by the address registration unit.

In such a search support device, if there is homepage information to be added as a part of the category menu, the icon of the category that contains the information of the added homepage can be visually changed when the category menu is displayed on the display unit. As a result, the category containing the additionally registered homepage information can be visually recognized.

Further, to achieve the second object, the present invention provides a search support method in which a search process for an address indicating the location of desired information on a network is requested based on search information associated with the desired information. This search support method includes the steps of: storing a category menu in which predetermined categories are listed up; and generating search information related to a category selected from the category menu.

To achieve the third object, the present invention also provides a recording medium that stores a program for a computer to perform an operation with a search support device in which an address indicating the location of information accessible on a network is registered. The program stored in the recording medium includes: a procedure for classifying the address in accordance with a category associated with the accessible information; and a procedure for registering the address classified in accordance with the category.

The present invention also provides a recording medium that stores a program for a computer to perform an operation with a search support device in which a search process for an address indicating the location of desired information on a desired network is requested based on search information associated with the desired information. The program stored in the recording medium includes: a procedure for storing a category menu in which predetermined categories are listed up; and a procedure for generating search information associated with a category selected from the category menu.

The above recording medium of the present invention may store a program that further includes a procedure for generating the category menu.

Various types of recording media can be employed as the recording medium of the present invention. Examples of such recording media include magnetic recording media that magnetically record information, such as a CD-ROM, a floppy disk, and a magneto-optical (MO) disk, and semiconductor memories that electrically record information, such as a ROM and a flash memory.

### BRIEF DESCRIPTION OF THE DRAWINGS

The features and advantages of the present invention will become more apparent from the following detailed description, with reference to the accompanying drawings.

FIG. 1 is a flowchart of a series of processes for searching for a homepage and registering a bookmark;

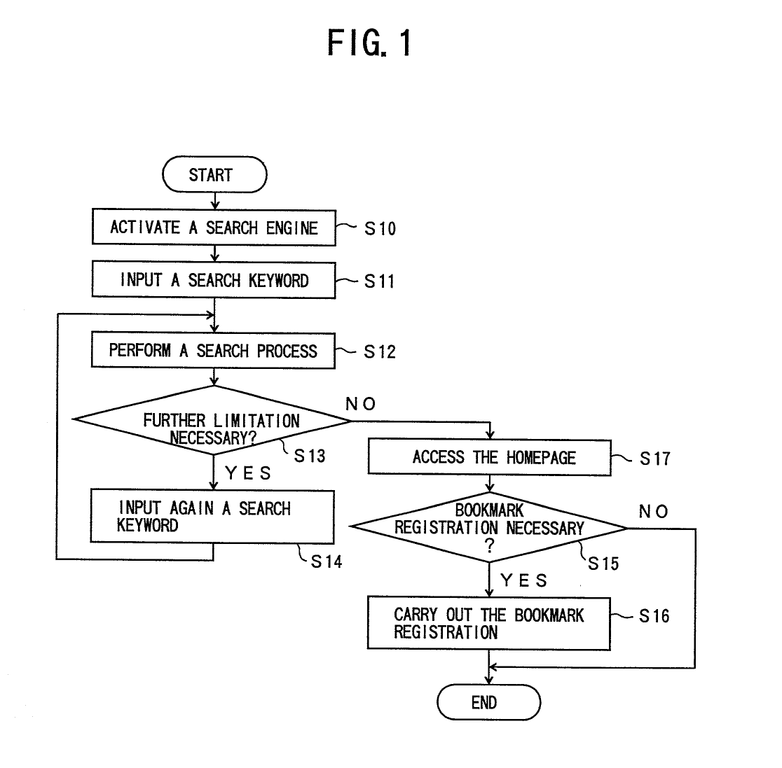

FIG. 2 shows examples of browser screens displayed on a display unit;

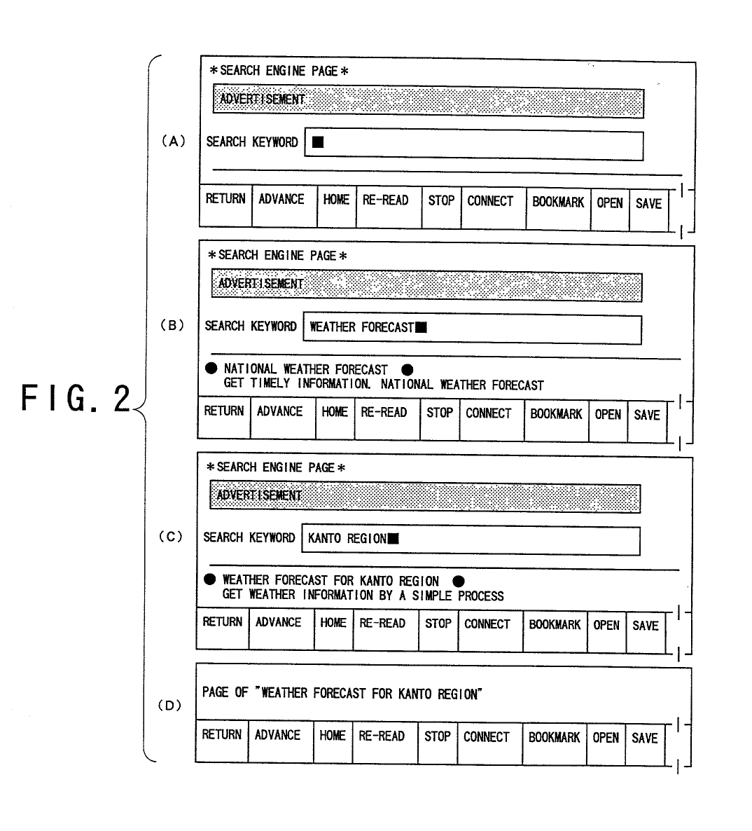

FIG. 3 shows examples of browser screens displayed on a display unit;

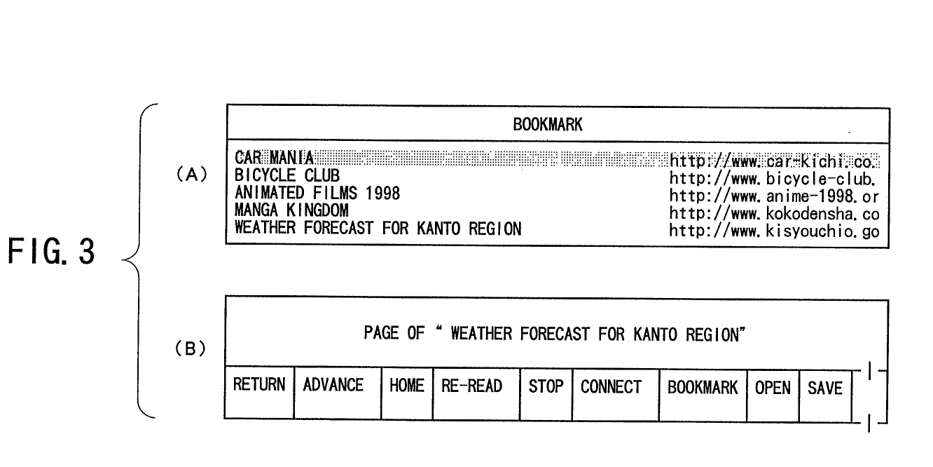

FIG. 4 shows the structure of the hardware of a computer that embodies a search support device in accordance with the present invention;

FIG. 5 is a flowchart of a first embodiment of procedures of a computer that embody a registration process performed by the search support device in accordance with the present invention;

FIG. 6 shows the structure of an example definition entry;

FIG. 7 shows the structure of an example menu;

FIG. 8 shows browser screens displayed on a display unit;

FIG. 9 illustrates a method for generating a command to be actually inputted into the search engine from a search character string;

FIG. 10 is a flowchart of procedures performed by a computer that embody a selection process performed by the search support device in accordance with the present invention;

FIG. 11 shows browser screens displayed on the display unit;

FIG. 12 is a flowchart of procedures performed by a computer that embody a delete process performed by the search support device in accordance with the present invention;

FIG. 13 is a flowchart of a second embodiment of procedures performed by a computer that embody a registration process performed by the search support device in accordance with the present invention;

FIG. 14 shows browser screens displayed on the display unit;

FIG. 15 illustrates the production of a definition entry and a control table from a selection record;

FIG. 16 is a flowchart of the production of the definition entry and the control table from a selection record; and

FIG. 17 is a flowchart of a third embodiment of procedures performed by a computer that embody a registration process performed by the search support device in accordance with the present invention.

### PREFERRED EMBODIMENTS FOR CARRYING OUT THE INVENTION

The following is a description of embodiments of the present invention, with reference to the accompanying drawings.

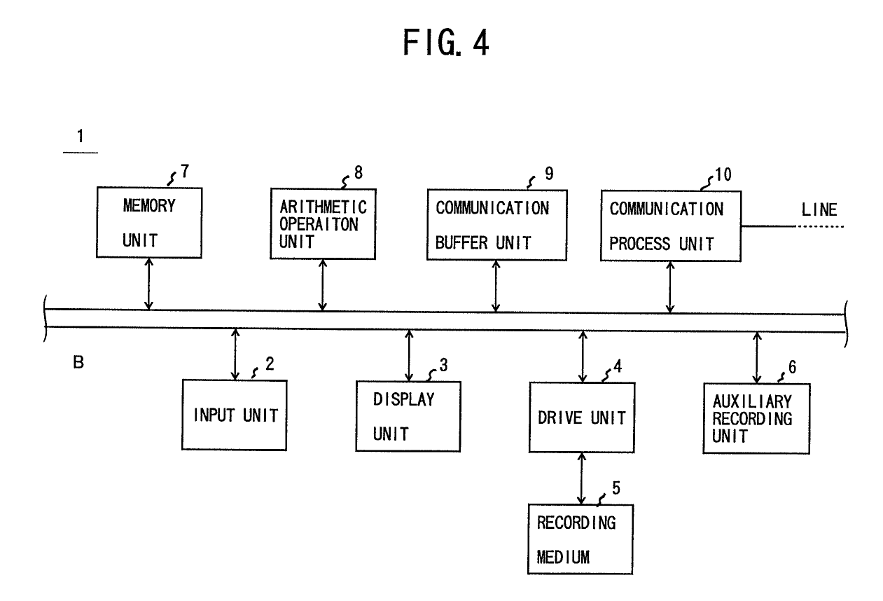

FIG. 4 shows the structure of the hardware of a computer that embodies a search support device in accordance with the present invention.

In FIG. 4, a computer 1 comprises an input unit 2, a display unit 3, a drive unit 4, a recording medium 5, an auxiliary recording unit 6, a memory unit 7, an arithmetic operation unit 8, a communication buffer unit 9, and a communication process unit 10, all of which are connected to each other via a bus B.

The input unit 2 is constituted by a keyboard and a mouse handled by a user of the computer 1, and used to input operation signals into the computer 1. The display unit 3 displays various windows and data for operating the computer 1.

The communication buffer unit 9 temporarily stores data files for exchanging data with an external network via the communication process unit 10. The communication process unit 10 exchanges data with an external network through a communication means such as a telephone line, and transmits the data file from the communication buffer unit 9. The communication process unit 10 receives and stores data files into the communication buffer unit 9.

A program for the search support device is supplied by the recording medium 5 such as a CD-ROM. The recording medium 5 storing the program for the search support device is set to the drive unit 4, and the program is installed from the recording medium 5 into the auxiliary recording unit 6 via the drive unit 4.

The auxiliary recording unit 6 stores necessary files and data, as well as the installed program for the search support device. The memory unit 7 reads out and stores the program for the search support device from the auxiliary recording unit 6 When the computer 1 is activated or the search support device is used. The arithmetic operation unit 8 performs an operation for the search support device, in accordance with the program for the search support device stored in the memory unit 7.

In accordance with the program for the search support device, the memory unit 7 reads out the program for the search support device installed in the auxiliary recording unit 6, and the arithmetic operation unit 8 carries out the procedures described later.

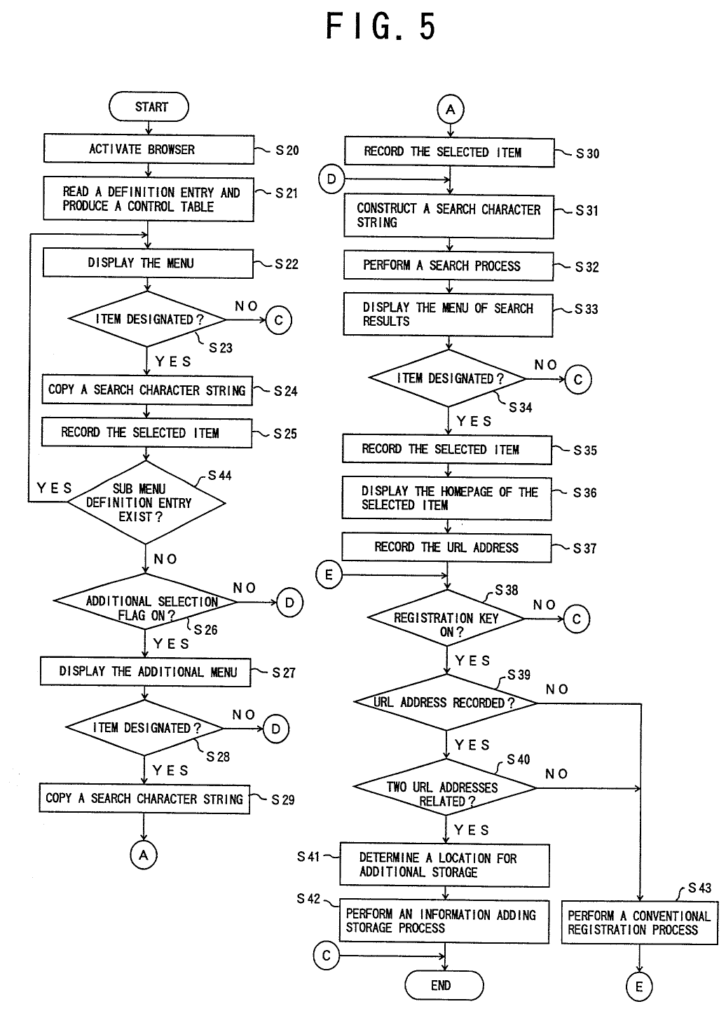

FIG. 5 is a flowchart of a first embodiment of the procedures performed by the computer that embody the registration operation performed by the search support device in accordance with the present invention. The registration operation performed by the search support device is a process for registering homepages which the user likes in a menu in which information is classified into categories.

In FIG. 5, a command is inputted through the input unit 2 to activate the browser for accessing a homepage in step S20. The search support device of the present invention may be automatically started with the activation of the browser, or the user may input an activating command through the input unit 2.

As the browser and the search support device are activated, the arithmetic operation unit 8 reads out a definition entry 18 from the auxiliary recording unit 6 and writes the definition entry 18 in the memory unit 17. Based on the definition entry 18, the menu to be displayed on the display unit 3 is produced in step S21.

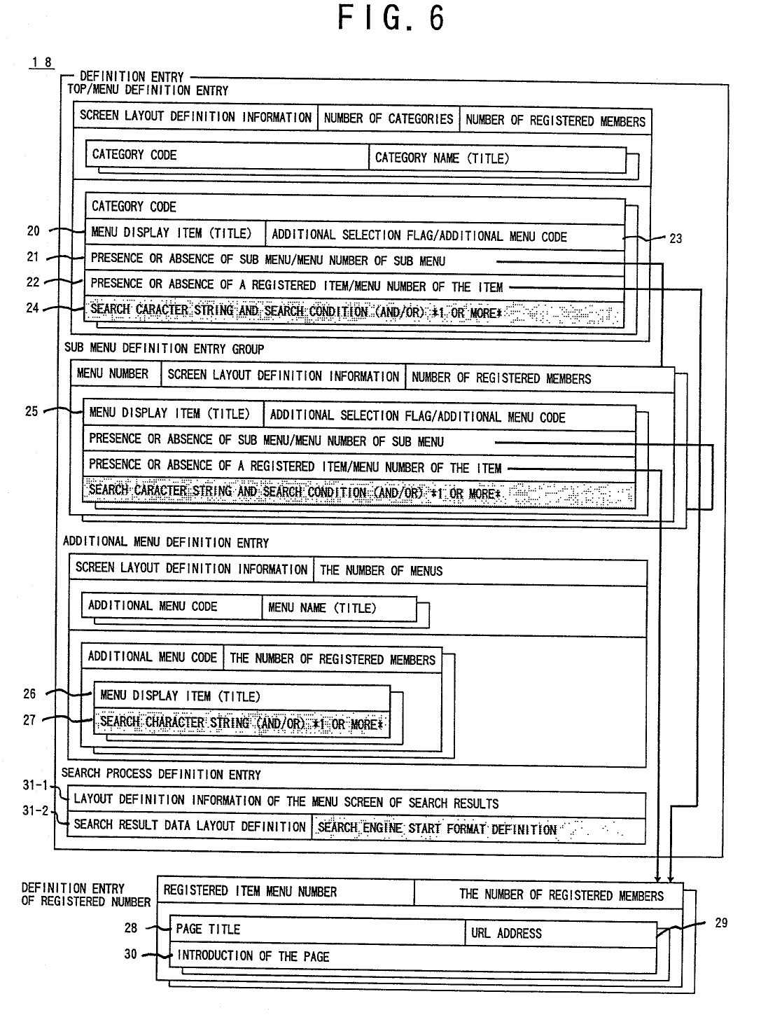

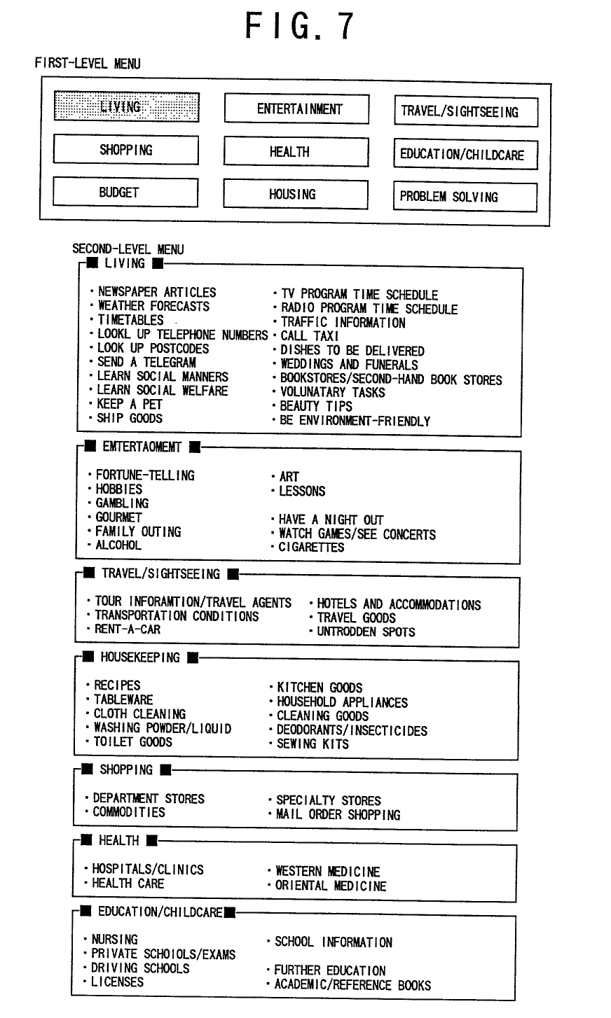

Referring now to FIGS. 6 and 7, the definition entry and the menu will be described. FIG. 6 shows the structure of an example of the definition entry, and FIG. 7 shows the structure of an example of the menu. The definition entry include top menu definition entry, sub menu items, additional menu items, registered definition entry, and search definition entry, as shown in FIG. 6. The definition entry define necessary information for producing a menu represented by a hierarchical structure having registered items classified into categories, as shown in FIG. 7.

For instance, the top menu definition entry includes a menu display item (title) 20, the presence or absence of a sub menu/the menu number of the sub menu 21, the presence or absence of a registered item/the menu number of the registered item 22, an additional selection flag/an additional menu cord 23, and a search keyword character string and search conditions 24.

The menu display item 20 defines a greater title to be displayed on the menu shown in FIG. 7. For instance, the menu display item 20 defines the names of greater items, such as “living” and “entertainment and hobby” shown in FIG. 7. The presence or absence of a sub menu/the menu number of the sub menu 21 defines whether or not a sub menu definition entry exists on the level under each greater item. The presence or absence of a registered item/the menu number of the registered item 22 defines whether or not a registered item exits on the level under each corresponding greater item. The additional selection flag/additional menu code 23 defines whether or not an additional menu definition entry is defined on the level under each corresponding greater item. The search keyword character string and search conditions 24 define a search keyword character string used when the greater item is selected.

The sub menu definition entry is substantially the same as the top menu definition entry, and the explanations for those are omitted. Among the sub menu definition entry, a display item 25 defines the names of middle items such as “read newspaper article” and “see weather forecast” in the menu shown in FIG. 7.

The additional menu definition entry includes a menu display item 26 and a search keyword character string and search conditions 27. The menu display item 26 of the additional menu definition entry defines an additional menu definition entry under a greater item defined by the top menu definition entry and a medium item defined by the sub menu definition entry.

For instance, an additional menu is used for further classifying the greater item and medium item, and defines smaller items such as “Kanto region” and “Chubu region” on the level under the “see weather forecast” in the menu shown in FIG. 7.

Next, a definition entry of a registered item is defined when the information of a homepage searched for by a search engine through a process. The definition entry of the registered item defines a page title 28, a URL address 29, and an introduction 30 for the page.

The search definition entry defines the layout definition informant of a menu screen of a search result 30-1, search result data layout definition information 30-2, and search engine start command format definition information 30-3.

An example of the menu produced based on the definition entry 18 described above is shown in FIG. 7. This menu shown in FIG. 7 may take various forms that are easy to use.

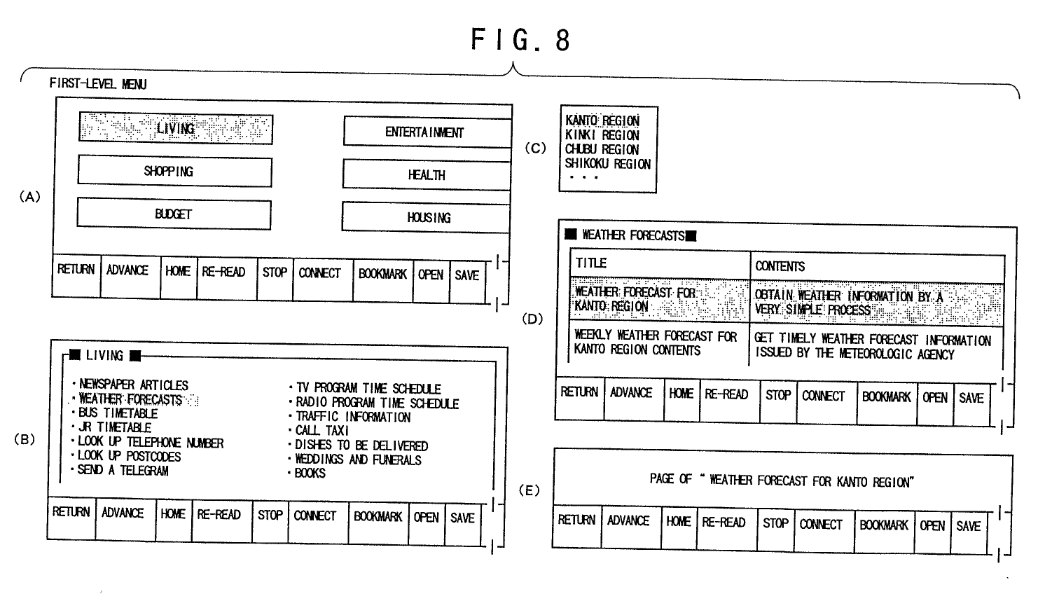

Referring back to FIG. 5, which is the flowchart of the first embodiment of the procedures performed by the computer that embodies the registration operation performed by the search support device, the memory unit 7 produces a control table in step (S21). The display unit 3 displays the control table as a menu shown in FIG. 8A in step S22.

The arithmetic operation unit 8 determines whether or not a command for designating an item constituting the menu has been inputted through the input unit 2 in step S23. If it is determined that a command for designating an item constituting the menu (“YES” in step S23), the search character string and the search conditions of the designated item are read out from the definition entry 18, and recorded as a search character string in the memory unit 7 in step S24. The menu display items 20 and 25 designated in step (S23) are recorded as selected items in the memory unit 7 in step S25.

Next, it is determined that whether or not a sub menu is defined under the selected item in step S44. If a sub menu is defined the operation moves on to step S22, and the sub menu shown in FIG. 8B is displayed.

If there is no sub menu definition, the arithmetic operation unit 8 determines whether or not the additional selection flag 23 of the item designated in step S23 is defined as “ON” in step S26. If the additional selection flag 23 of the item designated in step S23 is defined as “ON” (“YES” in step S26), the arithmetic operation unit 8 displays an additional menu shown in FIG. 8C on the display unit 3 in step S27.

The arithmetic operation unit 8 then determines whether or not a command for designating an item that constitutes the additional menu has been inputted in step S28. If it is determined that the command for designating an item that constitutes the additional menu (“YES” in step S28), the search character string and the search conditions 27 of the designated item are read out from the definition entry 18, and recorded as a search character string in the memory unit 7 in step S29. Also, the menu display item 26 designated in step S28 is recorded as a selected item in the memory unit 7 in step S30.

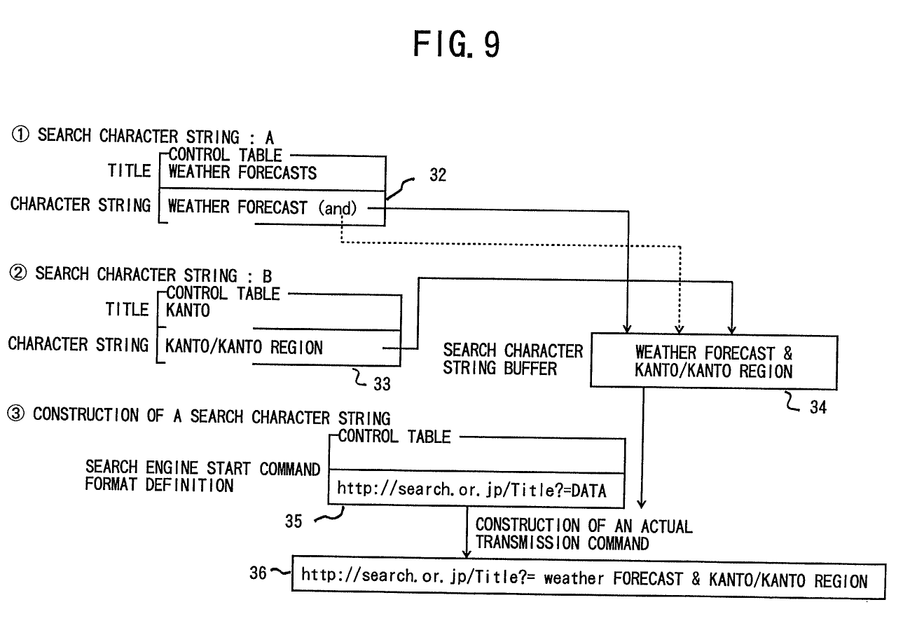

Next, the search character strings stored in the memory unit 7 in steps S24 and S29 are jointed to generate a search character string to be inputted in the search engine in step S31. Referring now to FIG. 9, a method of generating a command to be inputted in the search engine from a search character string will be described.

A search character string 32 recorded in the memory unit 7 in step S24 and the selected item recorded in the memory unit 7 in step S25 are recorded as a search character string A. A search character string 33 recorded in the memory unit 7 in step S29 and the selected item recorded in the memory unit 7 in step S30 are recorded as a search character string B.

In the example shown in FIG. 9, the selected item “see weather forecast” as the title of the search character string A and the search character string 32 “weather forecast (and)” are recorded in the memory unit 7. At this point, the search character strings are accompanied by the search conditions. In the case of the search character string A, the search condition is “and”. Likewise, a selected item “Kanto” and a search character string 33 “Kanto|Kanto region” are recorded as the title of the search character string B in the memory unit 7.

The search character string 32 “weather forecast (and)” and the search character string 33 “Kanto|Kanto region” are constructed as one search character string 34 “weather forecast & Kanto|Kanto region”, and recorded in the memory unit 7. After that, a search engine start command format definer 35 “http://search.or.jp/Title?=@DATA” is read out. The search string 34 is substituted in “@DATA”, so that an actual transmission command 36 “http://search.or.jp/Title?=weather forecast & Kanto|Kanto region” is constructed.

Next, the transmission command constructed in step S31 is transmitted to the browser. By doing so, the search character 34 is inputted in the search engine via the communication buffer unit 9 and the communication process unit 10, and the search process is carried out by the search engine in step S32. In other words, the telephone line usage starts at this point.

A result of the search process by the search engine is supplied to the memory unit 7 via the commination buffer unit 9 and the communication process unit 10, and analyzed and divided into various data by a search result data layout 31-2. In accordance with these data and a layout definition information 31-1 of a menu screen of the search result, a search result menu is displayed on the display unit 3 as shown in FIG. 8D in step S33.

The arithmetic operation unit 8 determines whether or not a command that designates an item constituting the search result menu has been inputted through the input unit 2 in step S34. If it is determined that the command that designates an item constituting the search result menu (“YES” in step S34), the information on the designated item, such as its name sand contents, is recorded as the selected item in the memory unit 7 in step S35.

The arithmetic operation unit 8 then transmits the URL address of the homepage of the item designated in step S34 to the browser, so that the contents of the homepage can be displayed on the display unit 3, as shown in FIG. 8E, via the communication buffer unit 9 and the communication process unit 10 in step S36. Next, the URL address of the homepage displayed on the display unit 3 is recorded in the memory unit 7 in step S37.

With the homepage being displayed on the display unit 3, it is determined whether or not a bookmark registration command contained in the browser has been inputted through the input unit 2 in step S38. If it is determined that the bookmark registration command has been inputted (“YES” in step S38), it is determined whether or not the recorded URL address is found in the memory unit 7 in step S39.

If it is determined that the recorded URL address is found in the memory unit 7 (“YES” in step S39), the arithmetic operation unit 8 determines in step S40 whether or not a “steady relationship” is maintained between the URL address recorded in the memory unit 7 in step S37 and the URL address of the homepage displayed on the display unit 3 when the bookmark registration command is inputted in step S38.

The “steady relationships” means a situation in which the URL address of the homepage displayed on the display unit 3 when the bookmark registration command is inputted in step S38 is identical to or lower than the URL address recorded in the memory unit 7 in step S37.

If it is determined that the “steady relationship” is maintained between the two URL addresses (“YES” in step S40), the storage location of the information of the homepage displayed on the display unit 3 at the time of the input of the bookmark registration command into the definition entry and the control table is determined in step S41, in accordance with the control table 18 and the selected items recorded in the memory unit 7 in steps S25 and S30.

Referring to FIGS. 8A to 8E, for instance, the memory unit 7 stores the medium item “see weather forecast shown in FIG. 8B and the small item “Kanto” shown in FIG. 8C as the selected items recorded in steps S25 and S30. The item “Weather Forecast in the Kanto Region” shown in FIG. 8D is searched for with the search character string “weather forecast & Kanto|Kanto region” associated with the medium item “see weather forecast” and the small item “Kanto”. Accordingly, the newly detected item “Weather Forecast in the Kanto Region” can be considered to be a category steadily associated with the medium item “see weather forecast and the small item “Kanto”, and the storage location is determined to be a level under the medium item “see weather forecast” and the small item “Kanto”.

To register the newly detected item at the location determined in step S41, the arithmetic operation unit 8 sets the name of the homepage in the page title 28, the contents of the homepage in the introduction 30, and the URL address of the homepage at the time of the input of the registration command in the URL address 29. The arithmetic operation unit 8 then generates a definition entry for the registered item, and performs an information adding storage process for the definition entry and the control table in step S42. Here, the processed definition entry and control table are recorded in the auxiliary recording unit 6 if necessary. The information adding storage process is performed to store the page title 28, the URL address 29, and the introduction 30.

If no item is designated in steps S23 and S34 and no bookmark registration command is inputted in step S38, the operation may be suspended until an item is designated, or if no item is designated over a predetermined period of time, the operation can be terminated. If the additional selection flag is not defined as “ON” in step S26 and no item is designated in step S28, the construction of a search character string is continued in step S31. Also, if no URL address is recorded in step S39 and no steady relationship is maintained with any URL address in step S40, the bookmark registration operation as a conventional function of the browser is performed in step S43, and the process of step S38 is continued.

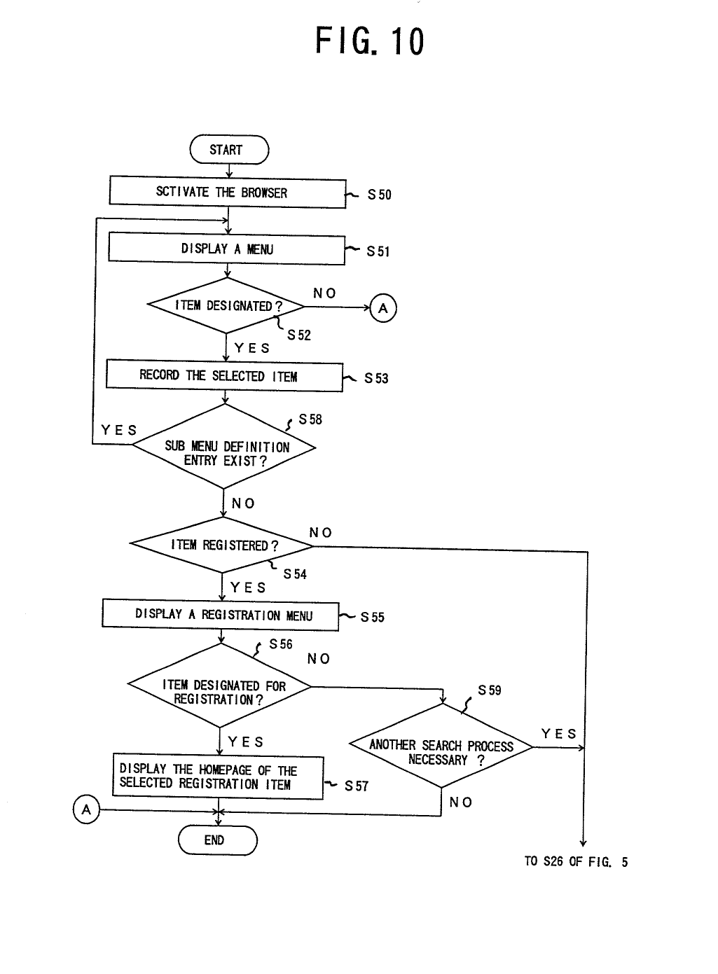

FIG. 10 is a flowchart of one embodiment of procedures performed by a computer that embodies the selection process performed by the search support device in accordance with the present invention. The selection process performed by the search support device is to select an item that is registered in accordance with the flowchart shown in FIG. 5 from a menu in which information is classified into categories.

In FIG. 10, a command for activating the browser for accessing a homepage is inputted through the input unit 2 in step S50. The search support device of the present invention may be automatically started by activating the browser, or a user may input a command for starting the search support device through the input unit 2.

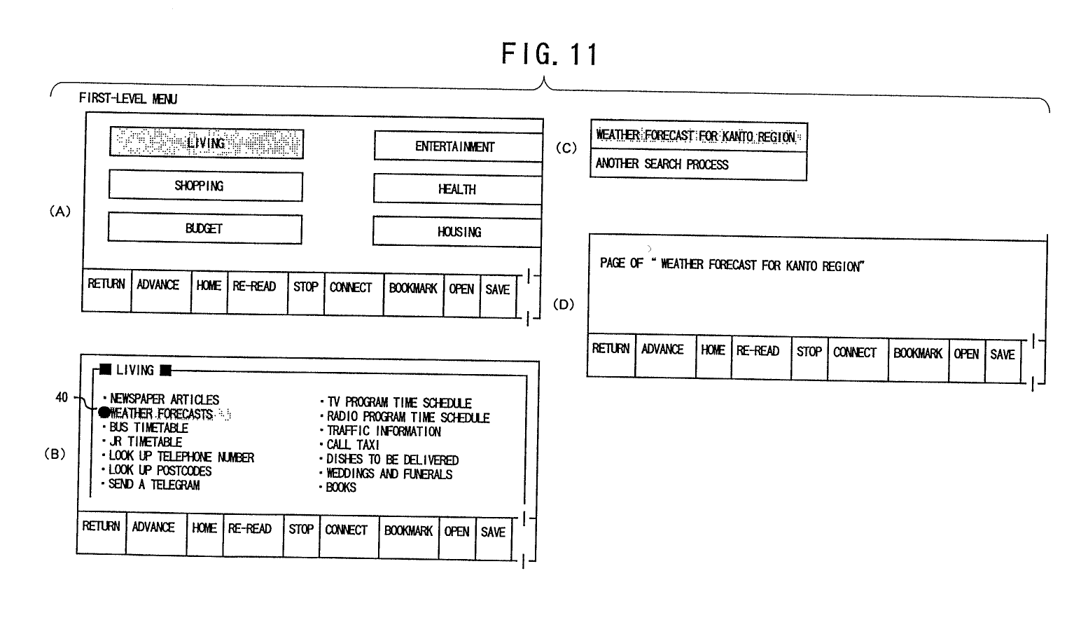

As the browser and the search support device are activated, the arithmetic operation unit 8 reads out the control table from the auxiliary recording unit 6 or the memory unit 7, and displays a menu shown in FIG. 11A on the display unit 3 in step S51. If no display unit is provided in the auxiliary recording unit 6 and the memory unit 7, the definition entry is read out from the auxiliary recording unit 6, and a control table is produced based on the definition entry.

The arithmetic operation unit 8 determines whether or not a command for designating an item constituting a menu shown in FIG. 11A has been inputted through the input unit 2 in step S52. If it is determined that the command for designating an item constituting the menu has been inputted (“YES” in step S52), the designated item is recorded as a selection item in the memory unit 7 in step S53. Next, it is determined whether or not a sub menu is defined under the selection item in step S58. If a sub menu is defined, the operation moves on to step S51 so as to display a sub menu shown in FIG. 11B.

If no sub menu is defined, the arithmetic operation unit 8 determines, in step S54, whether or not a registered item is contained in the item designated in step S52. If there is a registered item in the designated item, the arithmetic operation unit 8 displays a registration menu shown in FIG. 11C on the display unit 3. As shown in FIG. 11B, an item that has a registered item is marked with a larger dot, while items that do not has a registered item are marked with smaller dots, so that whether a registered item exists on a level under each item can be easily determined.

The arithmetic operation unit 8 then determines whether or not a command for designating a registered item has been inputted through the input unit 2 in step S56. If the command for designating a registered item has been inputted (“YES” in step S56), the arithmetic operation unit 8 reads out the information (the URL address 29) as to the homepage of the selected registered item from the control table, and supplies the information to the browser. The arithmetic operation unit 8 then displays the homepage of the supplied URL address on the display unit 3 by the browser in step S57.

In the previous process, if no item or registered item is designated in step S52, the operation may be suspended until an item is designated. If no item is designated over a certain period of time, the operation may be stopped. If there is no registered item in step S54 and a registered item is again searched for, the control operation moves on to step S26 of FIG. 5, and the search process is continued.

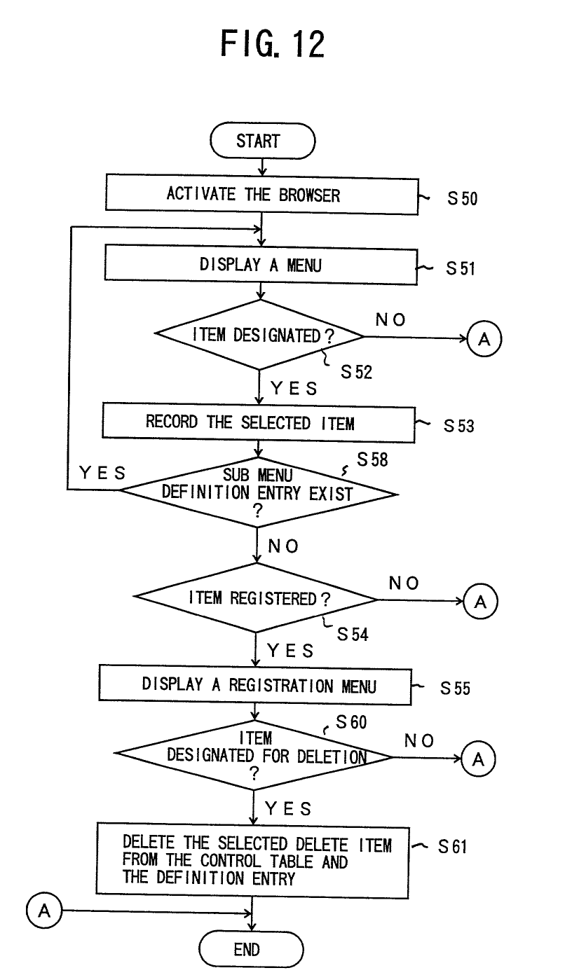

FIG. 12 is a flowchart of procedures performed by the computer that embody a delete process performed by the search support device in accordance with the present invention. The delete process performed by the search support device is a process to delete an item that has been registered in accordance with the flowchart of FIG. 5 from the menu in which information is classified into categories.

The flowchart shown in FIG. 12 is substantially the same as the flowchart shown in FIG. 10, except for one part. Accordingly, the same procedures as in the flowchart of FIG. 10 are denoted by the same reference numerals, and explanations for those are omitted. In FIG. 12, a registration menu is displayed on the display unit 3 through steps S50 to S55 and S58.

The arithmetic operation unit 8 determines whether or not a command for designating an item to be deleted has been inputted through the input unit 2 in step S60. If the command for designating an item to be deleted has been inputted (“YES” in step S60), the arithmetic operation unit 8 deletes the information of the homepage of the selection item from the control table and the definition entry in step S61. If necessary, the control table and the definition entry updated in step S61 are stored in the auxiliary recording unit 6. In the previous process, if no item to be deleted is designated in step S60, the operation may be suspended until an item is designated. If no item is designated over a certain period of time, the operation may be stopped.

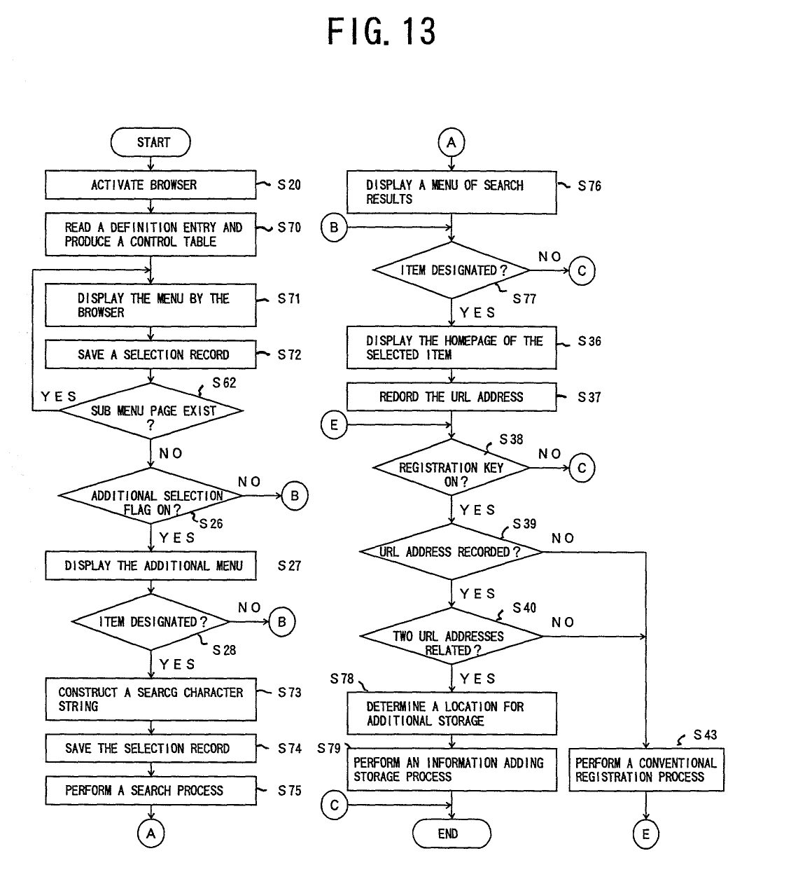

FIG. 13 is a flowchart of a second embodiment of the procedures performed by the computer that embodies a registration process performed by the search support device in accordance with the present invention. The flowchart of the second embodiment shown in FIG. 13 is characterized in that a search result of the search engine is processed, and that the page of the search result of the search engine is displayed without displaying its own menu of search results. The flowchart of FIG. 13 is substantially the same as the flowchart of FIG. 5, except for one part. In FIG. 13, the same procedures as in the flowchart of FIG. 5 are denoted by the same reference numerals, and explanations for them are omitted.

In FIG. 13, the browser and the search support device are activated in step S20. As the browser and the search support device are activated, the arithmetic operation unit 8 communicates with the server via the communication buffer unit 9 and the communication process unit 10, and writes a definition entry supplied from the server into the memory unit 7. Based on the definition entry, the arithmetic operation unit 8 produces a control table, and stores the control table in the auxiliary recording unit 6, if necessary, in step S70.

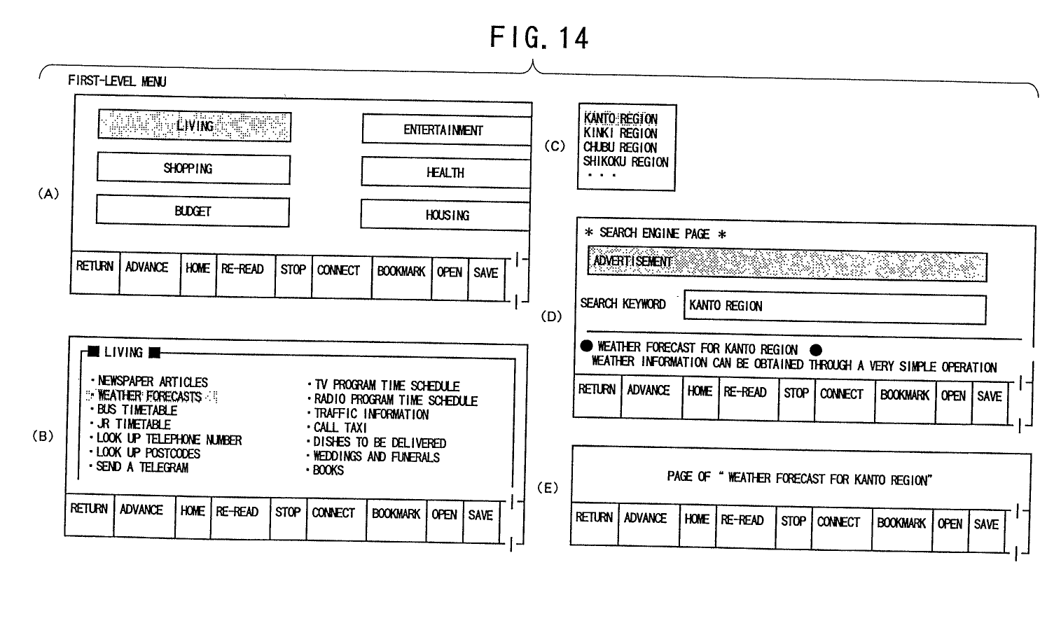

The browser is continued being operated, and menus shown in FIGS. 14A and 14B are displayed in step S71. The menus shown in FIGS. 14A and 14B are category menus especially for search on the server produced in the HTML format, but not a page that belongs to the search engine.

The arithmetic operation unit 8 records a selection record selected by a user handling the category menu shown in FIG. 14A in the memory unit 7 in step S72. If there is a sub menu, the operation returns to step S71, and the menu shown in FIG. 14B is displayed. If there is no sub menu page and the additional selection flag is set to “ON”, the additional menu is displayed on the display unit 3 through steps S26 and S27. When a command for designating an item constituting the additional menu is inputted, the search character string of the item selected in step S28 is jointed to the transmission command for the search engine recorded in the memory unit 7 in step S73.

The selection record on the additional menu is recorded in the memory unit 7 in step S74. Using the transmission command constructed in step S73, the search process is carried out by the search engine in step S75. A search result by the search engine is displayed on the display unit 3, as shown in FIG. 14D in step S76.

The arithmetic operation unit 8 determines whether or not a command for designating an item constituting the search result has been inputted through the input unit 2 in step S77. If the command for designating an item constituting the menu of the search result has been inputted (“YES” in step S77), the homepage of the item designated in step S77 is displayed on the display unit 3, as shown in FIG. 14E in step S36.

In steps S37 to S40, if it is determined that a certain relationship is maintained between the URL address recorded in the memory unit 7 in step S37 and the URL address of the homepage displayed on the display unit 3 at the time of the input of the bookmark registration command in step S38, a location for storing the information of the homepage displayed on the display unit 3 at the time of the input of the bookmark registration command into the control table is determined, in step S78, from the control table and the selection record recorded in the memory unit 7 in steps S72 and S74.

The arithmetic operation unit 8 then performs an information adding storage process for the definition entry and the control table, in step S79, thereby registering a newly detected item in the location determined in step S78. At this point, the definition entry and the control table subjected to the information adding storage process are recorded in the auxiliary recording unit 6, if necessary.

In the flowchart of the second embodiment shown in FIG. 13, the definition entry read and the control table production (step S70) may be performed immediately before the additional storage location determination (step S78) and the information adding storage process (step S79).

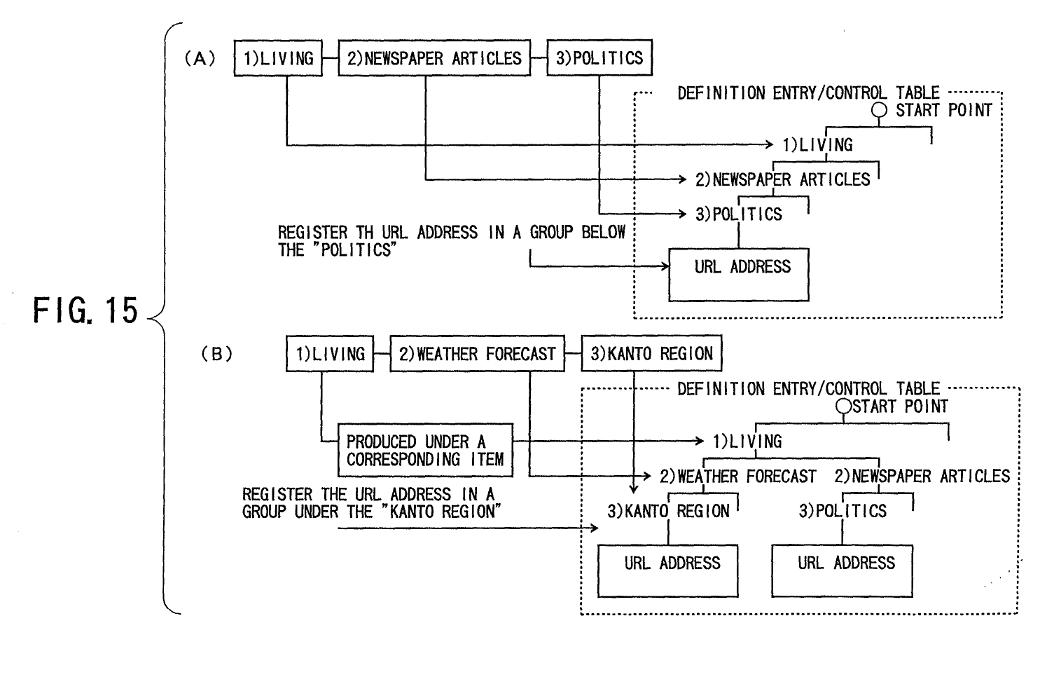

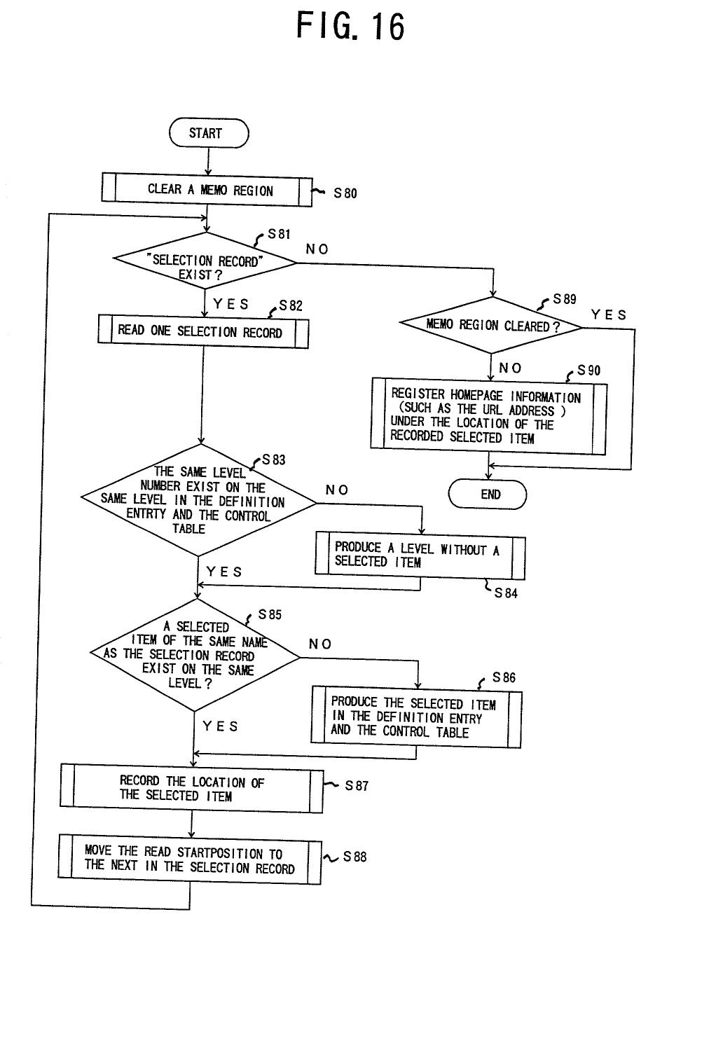

In the following, the procedures for producing a definition entry and a control table from a selection record will be described. FIG. 15 illustrates the production of a definition entry and a control table from a selection record. FIG. 16 is a flowchart of the production of the definition entry and the control table from the selection record.

The selection record contains the level number of an item selected by a user from the category menu shown in FIG. 14B, and the selection item. For instance, the example shown in FIG. 15A contains a selection item “living” at the level number 1, a selection item “news” at the level number 2, a selection item “politics” at the level number 3. In accordance with the selection record, the definition entry and the control table are produced, and the URL address of the homepage detected from the search character string associated with the three selection items is registered in a group a level below the selection item “politics” of the level number 3.

In an example shown in FIG. 15B, an addition process is performed for the definition entry and the control table that have been produced in advance. With selection items “living”, “weather forecast”, and “Kanto region” being recorded as a selection record at the level numbers 1, 2, and 3, respectively, no item is newly produced for the level number 1, because the selection item “living” has already been produced at the level number 1 in the definition entry and the control table.

Since the selection item “weather forecast” at the level number 2 is not identical to the selection item “news” produced at the level number 2 in the definition entry and the control table, the selection item “weather forecast” is newly produced at the level number 2, which is one level below the selection item “living” at the level number 1. Likewise, since the selection item “Kanto region” at the level number 3 is not identical to the selection item “politics” produced at the level number 3 in the definition entry and the control table, the selection item “Kanto region” is newly produced at the level number 3, which is one level below the selection item “weather forecast”.

The procedures of producing the definition entry and the control table as shown in FIG. 15 can be embodied by the flowchart shown in FIG. 16.

In FIG. 16, if any data is recorded in a memo region to be used in the process of producing the definition entry and the control table from the selection record prepared in the memory unit 7, the arithmetic operation unit 8 erases the data and clears the memo region to a non-data recorded state (hereinafter referred to as “cleared state”) in step S80.

The arithmetic operation unit 8 determines whether or not selection records are recorded in the memory unit 7 in step S81. If selection records are recorded in the memory unit 7 (“YES” in step S81), the arithmetic operation unit 8 reads out one of the selection records in step S82.

The location of the level of the selection record read out in step S82 is checked from the level number, and it is determined whether or not the definition entry and the control table has a selection item at the location of the selection record in step S83. If the definition entry and the control table have a selection item at the location of the selection record (“YES” in step S83), the arithmetic operation unit 8 determines in step S85 whether or not the name of the selection item of the selection record is identical to the name of the selection item in the definition entry and the control table. On the other hand, if the definition entry and the control table have a selection item at the location of the selection record (“NO” in step S83), a new level is formed at the location of the selection record in the definition entry and the control table in step S84.

If the name of the selection item of the selection record is identical to the name of the selection item in the definition entry and the control table (“YES” in step S85), the location of the selection item of the selection record is recorded in the memo region in step S87. On the other hand, if the name of the selection item of the selection record is not identical to the name of the selection item in the definition entry and the control table (“NO” in step S85), the selection item is produced in the definition entry and the control table, and recorded in the memory unit 7 in step S86.

After the selection item is produced in the definition entry and the control table, the arithmetic operation unit 8 also records the location of the produced selection item in the memo region in step S87. The read start position of the selection record is moved to the next position in step S88, the procedures of step S81 to S88 are repeated.

If it is determined in step S81 that no selection records to be read next are recorded, it is then determined whether or not the memo region is in the cleared state in step S89.

If it is determined that the memo region is not in the cleared state (“YES” in step S89), the URL address of a desired homepage is registered on a level below the location of the selection item recorded in the memo region in step S90. If it is determined that the memo region is in the cleared state (“YES” in step S89), the operation is ended.

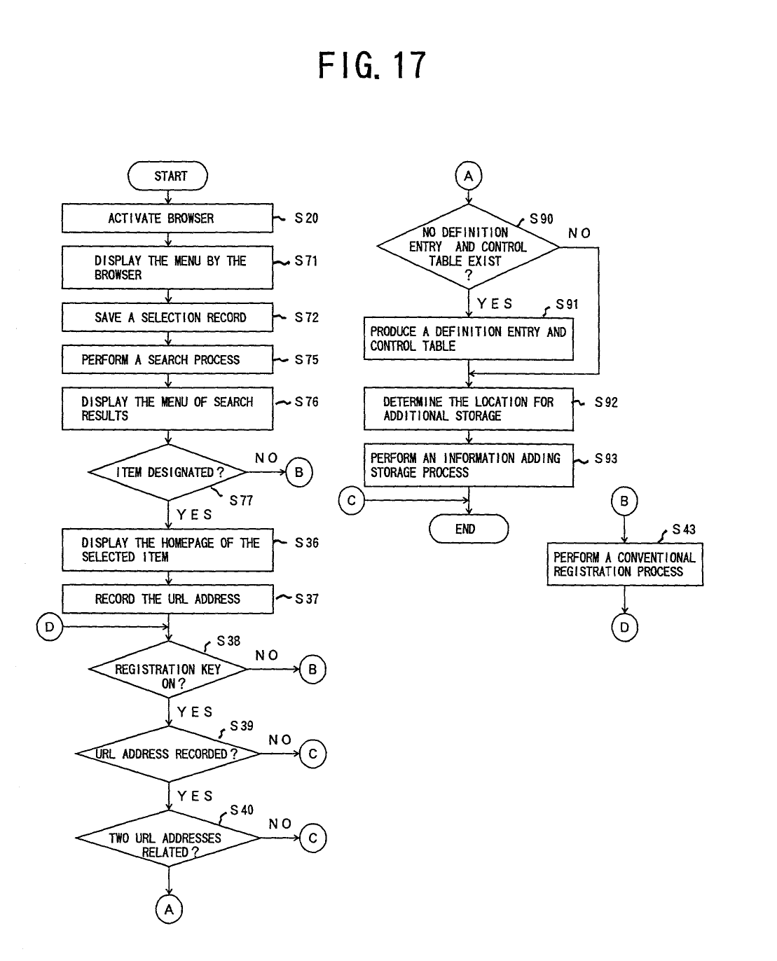

Referring now to FIG. 17, an example of procedures for producing the definition entry and the control table from the selection record described with reference to FIGS. 15 and 16 will be described. FIG. 17 is a flowchart of a third embodiment of procedures performed by a computer that embody a registration process performed by the search support device in accordance with the present invention. The flowchart of FIG. 17 is substantially the same as the flowchart of FIG. 13, except for one part. Accordingly, in the flowchart of FIG. 17, the same procedures as in the flowchart of FIG. 13 are denoted by the same reference numerals, and explanations for them are omitted.

In FIG. 17, the browser and the search support device are activated in step S20. In steps S71 and S72, a selection record selected in terms of categories by a user handling the browser is recorded in the memory unit 7. The user then performs a search process by the search engine, and displays a search result by the search engine on the display unit in steps S75 and S76.

The arithmetic operation unit 8 determines whether or not a command for designating an item constituting the search result has been inputted through the input unit 2 in step S77. If the command for designating an item constituting the menu of the search result has been inputted (“YES” in step S77), the homepage of the item designated in step S77 is displayed on the display unit 3 as shown in FIG. 14E in step S36.

In steps S37 to S40, if a certain relationship is maintained between the URL address recorded in the memory unit 7 in step S37 and the URL address of the homepage displayed on the display unit 3 at the time of the input of the bookmark registration command (“YES” in step S40), it is then determined whether or not the definition entry and the control table are recorded in the memory unit 7 in step S90.

If it is determined that the definition entry and the control table are not recorded in the memory unit 7 (“YES” in step S90), the arithmetic operation unit 8 produces the definition entry and the control table by the method described with reference to FIGS. 15 and 16 in step S91. If it is determined that the definition entry and the control table are recorded in the memory unit 7 (“NO” in step S90), the definition entry and the control table are not produced.

In accordance with the flowchart of FIG. 16, using the definition entry, the control table, and the selection record, the arithmetic operation unit 8 then determines, in step S92, the location for storing the information of the homepage displayed on the display unit 3 at the time of the input of the definition entry and the control table bookmark registration command.

The arithmetic operation unit 8 then performs an information adding storage process for the definition entry and the control table in step S93 so as to register the newly detected item at the location determined in step S92. Here, the definition entry and the control table subjected to the information adding storage process are recorded in the auxiliary recording unit 6, if necessary.

In the above embodiments, the auxiliary recording unit 6 shown in FIG. 4 is equivalent to the storage unit.

It should be understood that the present invention is not limited to the above embodiments, but various modifications and changes may be made without departing from the scope of the present invention.

[image]

[image]

[image]

[image]

[image]

[image]

[image]

[image]

[image]

[image]

[image]

[image]

[image]

[image]

[image]

[image]

[image]

1. A search support device in which an address indicating a location of information accessible on a network is registered, the device comprising:
a search unit that determines a category of an address designated for registration based on a definition entry and a selection record of a menu; and
a registration unit that registers an address in the category.

2. The search support device as claimed in claim 1, wherein the registration unit registers the address designated for registration in the category containing the registered address when located at the same level as the address designated for registration.

3. A search support method by which an address indicating a location of information accessible on a network, the method comprising the steps of:
determining a category of an address designated for registration based on a definition entry and a selection record of a menu; and
registering an address in the category.

4. A search support device in which a search process for an address indicating a location of desired information on a network is requested based on search information associated with the information, the device comprising:
a category menu storage unit that stores a category menu in which predetermined categories are listed up; and
a search information generating unit that generates search information associated with a category selected from the category menu.

5. The search support device as claimed in claim 4, further comprising:
a display unit that displays an address in another form indicating the location of desired information detected based on the search information generated by the search information generating unit; and
an address registration unit that registers the address in the category menu when the address indicates information that can be accessed.

6. The search support device as claimed in claim 5, further comprising an address selection unit that selects the address registered in the category menu so as to make an access to the location of the desired information.

7. The search support device as claimed in claim 5, further comprising an icon conversion unit that visually changes the category in which the address is registered by the address registration unit.

8. A search support method by which a search process for an address indicating a location of desired information on a network is requested based on search information associated with the desired information, the method comprising:
storing a category menu in which predetermined categories are listed up; and
generating search information associated with a category selected from the category menu.

9. A recording medium which stores a program for a computer to perform an operation with a search support device that registered an address indicating a location of accessible information on a network, the program comprising:
a procedure for classifying the address in accordance with a category related to information that can be accessed at the address; and
a procedure for registering the address classified in accordance with the category.

10. A recording medium which stores a program for a computer to perform an operation with a search support device that requests a search process for an address indicating a location of desired information on a desired network based on search information associated with the desired information, the program comprising:
a procedure for storing a category menu in which predetermined categories are listed up; and
a procedure for generating search information associated with a category selected from the category menu.

11. The recording medium as claimed in claim 10, wherein the program further includes a procedure for generating the category menu.
